(19) United States
(12) Patent Application Publication
(10) Pub. No.: US 2020/0048507 A1
(43) Pub. Date: Feb. 13, 2020

(54) All-Weather Pressure-Sensitive Adhesive

(71) Applicant: GCP Applied Technologies Inc., Cambridge, MA (US)

(72) Inventors: MD Nasim Hyder, Lexington, MA (US); Robert A. Wiercinski, Lincoln, MA (US); Anandakumar Ranganathan, Lexington, MA (US); Jyoti Seth, Andover, MA (US)

(21) Appl. No.: 16/536,862

(22) Filed: Aug. 9, 2019

Related U.S. Application Data
(60) Provisional application No. 62/717,080, filed on Aug. 10, 2018.

(51) Int. Cl. C09J 7/38; C09J 153/02; C09J 11/08

(52) U.S. Cl. CPC C09J 7/387; C09J 153/02; C09J 2453/00; C09J 2201/606; C09J 11/08

(57) ABSTRACT

The present invention provides a non-cured-in-place waterproofing pressure-sensitive adhesive having a microfibrillar additive for achieving ideal balance between sag resistance at elevated temperatures and good adhesion at low temperatures. Waterproofing membranes comprising a carrier sheet and pressure-sensitive adhesive layer are also described, along with methods of manufacture.

### CROSS-REFERENCE TO RELATED APPLICATIONS

This PCT application claims priority to U.S. Provisional Patent Application No. 62/717,080, entitled “All-Weather Pressure-Sensitive Adhesive”, filed Aug. 10, 2018, the entirety of which is incorporated herein by reference.

### FIELD OF THE INVENTION

The invention relates to the field of pressure-sensitive adhesives, and more particularly to a non-cured-in-place waterproofing adhesive for providing membranes and barriers on building or engineering surfaces.

### BACKGROUND OF THE INVENTION

Two key performance characteristics for a pressure-sensitive adhesive (PSA) include good adhesion, especially at low temperatures, and good resistance to creep or flow (synonymous with sag resistance), especially at elevated temperatures. Each of these characteristics can be achieved individually; however, it is quite difficult to achieve both performance characteristics at the same time within a single PSA formulation. According to the conventional art, one strategy was to try to obtain any semblance of balance of these properties by adjusting the ingredients of each individual PSA formulation. Such ingredients include elastomers, tackifiers, and plasticizers. However, this approach has limitations, and it is difficult—and the conventional art has failed—to find the proper balance of ingredients.

Another option is to add rheology-modifying additives. Although some of these may be used to enhance creep or flow resistance, they typically do so at the expense of adhesion.

Accordingly, there is a serious need for a novel PSA that enhances sag resistance at high temperatures, while simultaneously maintaining a reasonable level of adhesion at low temperatures (e.g., 40° F. and lower). However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for improved PSA compositions is now met by a new, useful, and nonobvious invention.

In an embodiment, the current invention is a PSA composition, comprising an elastomer, a tackifier or bitumen, a plasticizer, and a microfibrillar rheology-modifying agent, wherein the composition is non-cured-in-place and is substantially devoid of structural diluents, radical addition diluents, curatives, cross-linkers, and liquid reactive oligomers.

Optionally, the elastomer may be butyl rubber, polyisobutylene, vinyl ethers, styrene-isoprene-styrene block copolymers, styrene-ethylene-butylene-styrene block copolymers, styrene-butadiene-styrene block copolymers, styrene-butadiene rubber, ethylene vinyl acetate copolymers, polyisoprene, polybutadiene, polychloroprene, natural rubber, or mixtures thereof.

Optionally, the tackifier may be rosin esters, hydrogenated rosin esters, dimerized rosin resins, modified rosin resins, aliphatic (C-5 resins) hydrocarbon resins, hydrogenated aliphatic resins, aromatic (C-9 resins) hydrocarbon resins, hydrogenated aromatic resins, mixed aliphatic/aromatic (mixed C-5/C-9 resins) hydrocarbon resins, terpene resins, terpene phenolic resins, or mixtures thereof.

Optionally, the plasticizer may be paraffinic oils, naphthenic oils, aromatic oils, mineral oils, liquid polyisobutylene, phthalates including alkyl, and mixed alkyl aryl, and phosphates including aryl, alkyl, mixed alkyl aryl, or mixtures thereof.

Optionally, the microfibrillar rheology-modifying additive may be an additive pulp, specifically a para-aramid pulp, in an amount of about 0.1% to about 3.0% by total weight of the composition. In an embodiment, the para-aramid pulp may have a fiber length of about 0.5 mm to about 2.0 mm and/or a surface area of about 3 m² per gram to about 12 m² per gram.

In certain embodiments, the PSA may be a non-bituminous hot melt PSA or a bituminous PSA. In the former case, the composition comprises the tackifier and a styrene block copolymer chosen from styrene-isoprene-styrene, styrene-butadiene-styrene, styrene-ethylene-butylene-styrene, or mixtures thereof. In the latter case, the composition comprises bitumen and a styrene block copolymer chosen from styrene-isoprene-styrene, styrene-butadiene-styrene, styrene-ethylene-butylene-styrene, or mixtures thereof.

Preferably, the PSA composition has a sag resistance of about 0.1 cm/hr or less at 240° F., and further can have a peel strength of about 1.5 pli or more at 40° F.

In other embodiments, the current invention is a waterproofing membrane, comprising a carrier sheet and a PSA composition described above. Optionally, the membrane can further include a release liner disposed in overlying relation to the PSA layer.

In an embodiment, the current invention is a waterproofing membrane, comprising a carrier sheet and a PSA layer, where the PSA layer has (i) a sag resistance of about 0.1 cm/hr or less at 240° F. and (ii) a peel strength of about 1.5 pli or more at 40° F. The PSA layer comprises an elastomer, a tackifier or bitumen, a plasticizer, and a microfibrillar rheology-modifying agent. The microfibrillar rheology-modifying agent is a para-aramid pulp in an amount of about 0.1% to about 3.0% by total weight of the PSA layer, wherein the para-aramid pulp has a fiber length of about 0.5 mm to about 2.0 mm and has a surface area of about 3 m² per gram to 12 m² per gram. The PSA layer is non-cured-in-place and is substantially devoid of structural diluents, radical addition diluents, curatives, cross-linkers, and liquid reactive oligomers. Optionally, the membrane further includes a release liner disposed in overlying relation to the PSA layer.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

An appreciation of the benefits and features of the present invention may be more readily comprehended by considering the following written description of exemplary embodiments in conjunction with the drawings, in which:

FIG. 1A is a micro-photograph of aramid pulp using transmitted light.

FIG. 1B is a micro-photograph of aramid pulp using a scanning electron microscope (SEM).

FIG. 2 is an illustration of various aramid pulp morphological structures.

FIG. 3 is an SEM photograph of aramid pulp blended into bituminous PSA in accordance with certain embodiments of the present invention.

FIG. 4 is a transmitted light micro-photograph of a modified bitumen PSA comprising aramid pulp in accordance with certain embodiments of the present invention.

FIG. 5 is a diagram of an exemplary membrane (10) of the present invention having a carrier sheet (12) and a PSA layer (14) comprising a microfibrillar rheology-modifying agent (e.g., para-aramid pulp).

FIG. 6 is a schematic diagram that illustrates test geometry of PSA samples for measuring sag resistance or flow.

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means±15% of the numerical. In an embodiment, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k*(RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

All percentages of components described herein shall be based upon total weight unless otherwise designated. For example, percentages of components of the PSA will be understood to be based on total weight of the PSA unless otherwise indicated.

In resolving the problems of conventional PSA designs, the present invention helps to achieve an ideal balance between good elevated-temperature sag resistance and good low-temperature adhesion, chemical curing is not required. The ideal balance of sag resistance (especially at elevated temperatures) and adhesion (especially at low temperatures) is achieved, at least in part, by adding a fibrillar additive to the PSA formulation.

In certain embodiments, the current invention is a composition for a non-cured-in-place PSA that can achieve an ideal combination of high-temperature sag resistance and low-temperature adhesion properties, where the composition comprises:

(a) at least one elastomer;

(b) at least one tackifier or bitumen;

(c) at least one plasticizer; and

(d) a microfibrillar rheology-modifying agent;
wherein the composition is non-cured-in-place and substantially devoid of structural diluents, radical addition diluents, curatives, cross-linkers, and liquid reactive oligomers.

In other embodiments, the current invention provides a membrane comprising: a carrier sheet (e.g., polymer film) and a pre-formed PSA layer comprising at least one elastomer, at least one tackifier or bitumen, at least one plasticizer, a microfibrillar rheology-modifying agent, wherein the composition is non-cured-in-place and substantially devoid of structural diluents, radical addition diluents, curatives, cross-linkers, and liquid reactive oligomers.

Within the context of the present disclosure, the terms “pressure-sensitive adhesive” or “PSA” refer to a material which forms a bond when pressure (e.g., by human hand or roller) is applied to accomplish a bond between the adhesive and the target substrate, such as a building wall, foundation, roof deck, or other construction surface. No solvent, water, or heat is needed to activate the adhesive. PSAs are used in waterproofing membranes, tapes, labels, glue dots, note pads, automobile trim, and a wide variety of other products.

The concept of PSAs may be comprehended in many situations using a convenient test. For example, one way to define a minimum requirement for a PSA material is the adhesion or sag adhesion test, applied at 73.4° F. and 39.2° F., as described in ASTM D1970-15, section 7.4 (2009). This test, as written, is intended for a modified bitumen PSA waterproofing membrane comprising a carrier sheet and a modified bitumen PSA layer. For the purpose of the present invention, however, this test may be used for any membrane comprising a carrier sheet and a bituminous or non-bituminous PSA layer. The minimum peel strength requirements are about 12 pounds per linear foot at 73.4° F. and about 1.5 pounds per linear foot at 39.2° F.

PSA materials that may be used in the present invention can include various types of PSAs. For example, the PSA material can include hot melt PSAs, including those deemed to constitute 100% solids, solvent-based PSA materials, and even water-based PSA materials. For water-based PSA, emulsion type is preferred.

Non-bituminous PSA materials can be chosen, for example, from elastomers such as butyl rubber, polyisobutylene, vinyl ethers, styrene-isoprene-styrene (SIS) block copolymers, styrene-ethylene-butylene-styrene (SEBS) block copolymers, styrene-butadiene-styrene (SBS) block copolymers, styrene-butadiene rubber (SBR), ethylene vinyl acetate copolymers, polyisoprene, polybutadiene, polychloroprene, natural rubber, and mixtures thereof. Other non-bituminous PSA materials are contemplated herein as well.

Preferably, a synthetic PSA is a hot melt adhesive based upon a block copolymer of SIS, SBS or SEBS. The publication Handbook of Pressure Sensitive Adhesive Technology by Satas (Van Nostrand Reinhold Company, Inc. (1982), which is incorporated herein by reference, provides a more detailed discussion of PSAs.

Another suitable option includes a non-bituminous synthetic PSAs comprising an amorphous polyolefin or mixture of such amorphous polyolefins. Amorphous polyolefin (APO) is defined as a polyolefin with a degree of crystallinity of less than 30% as measured by differential scanning calorimetry. These polymers can be either homopolymers of propylene or copolymers of propylene with one or more α-olefin comonomer(s). Examples of such α-olefin comonomer(s) include, but are not limited to, ethylene, 1-butene, 1-hexene, 1-octene, and 1-decene. Examples of APO polymers of the types herein described above are commercially available from Eastman Chemical Company, Kingsport, Tenn., under the trade name designation EASTOFLEX®; Huntsman Corporation, Houston, Tex., under the trade name REXTAC®; and Degussa Corporation, Parsipanny, N.J., under the trade name VESTOPLAST®. Like rubber based adhesives, these APO polymers can also be combined with a tackifier and plasticizer to produce a PSA. See Eastman bulletin “Pressure-Sensitive Adhesives Based on Amorphous Polyolefin From Eastman Chemical Company”.

Within the context of the present disclosure, the term “non-cured-in-place” means that the PSA composition is not chemically cured during or after application of the PSA to a substrate. The phrase “chemically cured,” in turn, refers to the use of a chemical reaction during curing of the PSA matrix or composition (e.g., formation of covalent or ionic bonds).

Within the context of the present disclosure, the term “tackifier” refers to chemical compounds used in formulating adhesives to increase the tack or stickiness of the surface of the adhesive. These are usually low-molecular weight compounds with high glass transition temperatures. It is contemplated that for purposes of the present invention, examples of suitable tackifiers include, but are not limited to, rosin esters, hydrogenated rosin esters, dimerized rosin resins, modified rosin resins, aliphatic (C-5 resins) hydrocarbon resins, hydrogenated aliphatic resins, aromatic (C-9 resins) hydrocarbon resins, hydrogenated aromatic resins, mixed aliphatic/aromatic (mixed C-5/C-9 resins) hydrocarbon resins, terpene resins, terpene phenolic resins, and mixtures thereof. Other suitable tackifiers are contemplated herein as well.

Within the context of the present disclosure, the term “bitumen” refers to a black and highly viscous liquid or semi-solid form of petroleum, and is sometimes referred to as asphalt, bituminous adhesive, or asphaltic adhesive. It is a residue of the distillation process of crude petroleum oils.

Within the context of the present disclosure, the term “plasticizer” refers to materials that can be added to or within a composition for the general purpose of increasing pliability or otherwise altering/improving desirable properties of the composition. Suitable plasticizers include, but are not limited to, paraffinic oils, naphthenic oils, aromatic oils, mineral oils, liquid polyisobutylene, phthalates including alkyl, and mixed alkyl aryl, and phosphates including aryl, alkyl, and mixed alkyl aryl groups.

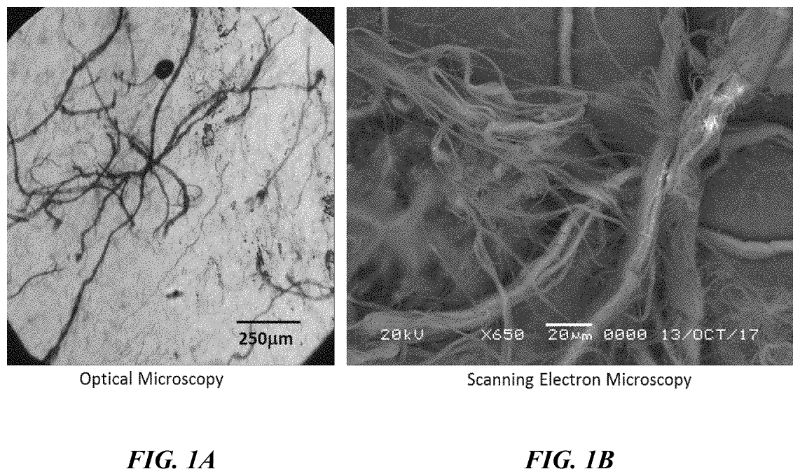

Within the context of the present disclosure, the terms “microfiber” and “microfibrillar” refer to the structure of aramid pulp, particularly when viewed under microscope, having resolution sufficient to discern morphological structure at micron levels. A preferred aramid pulp is a para-aramid (CAS NO. 26125-61-1) pulp (“para-aramid” or “p-aramid”). KEVLAR® pulp (manufactured by DuPont) and TWARON® pulp (manufactured by Teijin) are examples of commercially available para-aramid pulps. Transmitted light and SEM photomicrographs of the para-aramid pulp material, before incorporation into a PSA, are shown in FIGS. 1A-1B.

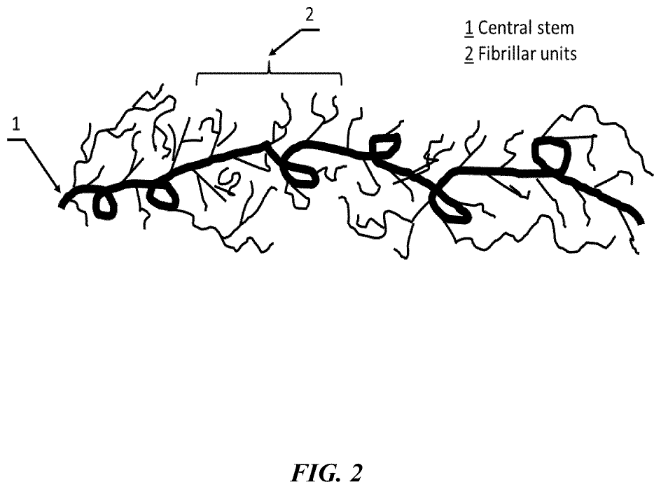

As shown in FIG. 2, the central stem of the micro-fibrillar unit can be about 5-25 μm in diameter and about 0.5-2.0 mm in length. The individual branches or fibrils are on the order of 1 μm in diameter. The surface area can have a range of about 4-10 g/m².

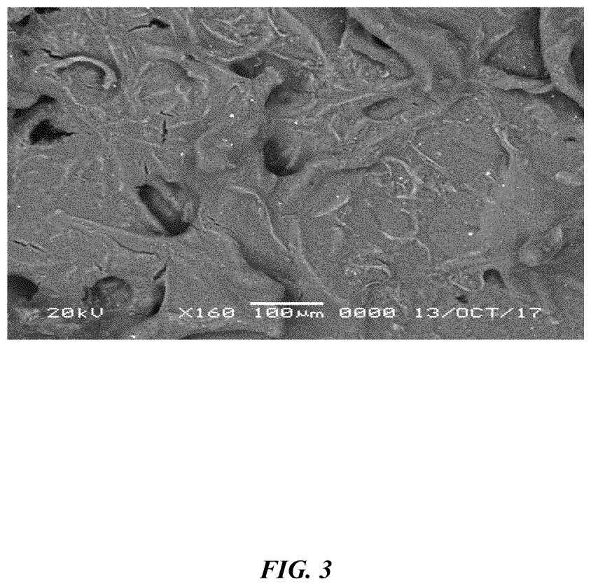

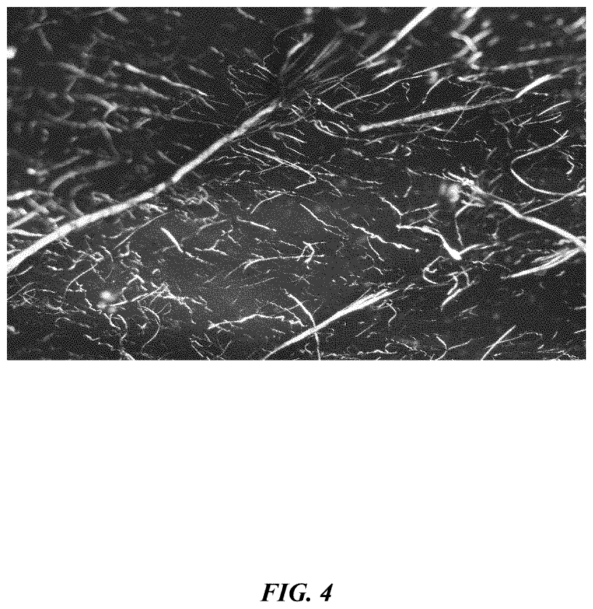

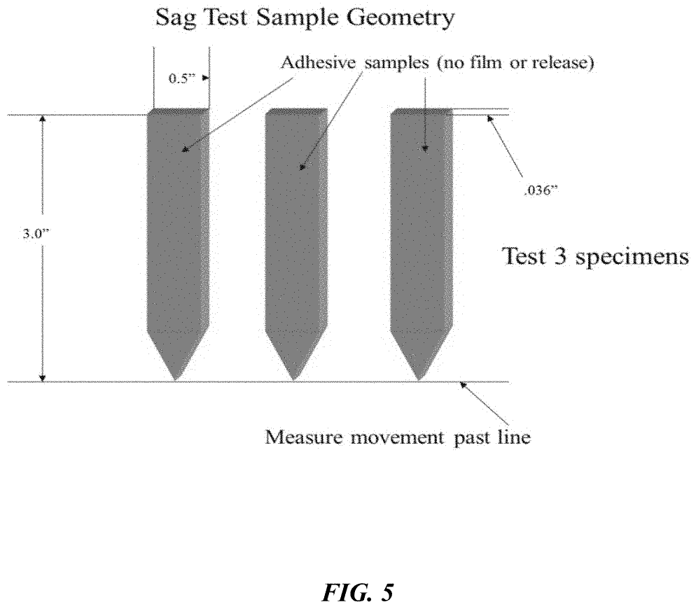

Para-aramid microfibers useful in the present invention provide a unique combination of high strength, high modulus, toughness, and thermal stability. When incorporated in a hot-melt PSA, para-aramid microfibers do not react or decompose, nor do they melt at the processing temperatures. Rather, aramid microfibers (contained in aramid pulp), or more specifically para-aramid microfibers (contained in para-aramid pulp), create an entangled network which provides mechanical support to the adhesive matrix. The entangled network provided by para-aramid microfibers is indicated in the SEM microphotograph in FIG. 3 and transmitted light microphotograph in FIG. 4.

A preferred range amount of aramid pulp, e.g., para-aramid pulp, in exemplary PSAs of the present invention is about 0.1%-3.0%. A more preferred range is about 0.3%-1.0%. All weight percentages of PSA components provided are based on total weight (solids) of the PSA material or layer.

Exemplary PSA layers or materials used in the present invention include non-bituminous (or “synthetic”) PSA material, which optionally, although preferably, may contain one or more typical additives as may be chosen from light absorbers (e.g., carbon black, benzotriazoles, hydroxyphenyl-triazine, benzophenones, etc.); light stabilizers (e.g., hindered amines), antioxidants (e.g., hindered phenols); fillers (e.g., calcium carbonate, silica, titanium dioxide, etc.); plasticizers or other rheological additives; and mixtures thereof.

Preferred synthetic adhesives useful for the PSA layer contain light absorbers, light stabilizers, and antioxidants, as these tend to increase durability of the PSA layer over time.

Within the context of the present disclosure, the term “carrier sheet” refers to a film, sheet, fabric, extrusion coated woven and non-woven fabrics film, woven or non-woven material, or combination thereof. The carrier sheet provides mechanical strength and waterproofing integrity to the membrane. The carrier sheet typically has a thickness of about 0.02-2.0 mm, preferably about 0.05-1.0 mm, and should comprise a generally smooth surface. Suitable materials for films and extrusion coatings include, but are not limited to, polypropylene, polyethylene, ethylene-propylene copolymers, ethylene-olefin copolymers, ethylene-vinyl acetate copolymers, polyvinyl acetate, polyethyl acrylate, polytetrafluoroethylene (PTFE), polyvinylidene fluoride (PVDF), polyethylene terephthalate (PET), polyvinyl chloride (PVC), polyamides and combinations thereof. Polyethylene and polypropylene are preferred.

In an embodiment, the carrier sheet comprises a thermoplastic film of high density polyethylene (HDPE). Fabrics may be woven or non-woven and may comprise polyethylene, polypropylene, polyethylene terephthalate and polyamide. A woven polypropylene fabric is particularly suitable.

In another embodiment, the carrier sheet is a cross laminated high density polyethylene film (e.g., VALERON® manufactured by ITW). Another exemplary carrier sheet is a laminate of the cross laminated high density polyethylene film with a polyethylene terephthalate film. Yet another exemplary carrier sheet is a blown polyethylene or polypropylene film laminated to a polyethylene terephthalate film. Thicknesses of these carrier sheets may have a range of about 0.025-0.5 mm (1-20 mils), preferably about 0.051-0.25 mm (2-10 mils).

In certain embodiments, the PSA materials or layers can comprise a bituminous PSA, for example a styrene block copolymer selected from SIS, SBS, SEBS, or a mixtures thereof; a plasticizer; bitumen; and a para-aramid pulp. The rubber level can be about 10%-22% by weight of the total PSA layer; the bitumen level can be about 43%-85% by weight; the plasticizer can be about 5%-35% by weight; and the level of para-aramid pulp can be about 0.1%-3.0% and preferably 0.2% to 1.0% by weight.

Compositions comprising a PSA including an aramid pulp may be produced by any one of a number of different mixing procedures. The following description of the manufacturing process is focused on 100% solids, hot melt PSAs that comprise styrene butadiene block copolymers. However, the present invention is not limited to these types of PSAs. These PSAs may include non-bituminous or bituminous materials. Non-bituminous PSAs may include elastomer, tackifier, and plasticizer; similarly, bituminous adhesives comprise elastomer, asphalt, and plasticizer. Either PSA type further includes a microfibrillar material, such as an aramid pulp or more specifically para-aramid pulp.

Various types of mixers may be used for non-bituminous and bituminous PSAs comprising styrene butadiene block copolymers. For the non-bituminous adhesives, a low-speed paddle mixer is generally preferred. However, a high shear mixer like a COWLES dissolver, a batch type rotor stator mixer, or an in-line rotor stator mixer may be used. For bituminous PSAs, a high shear mixer, particularly the rotor stator mixer is typically used. For incorporation of aramid pulp into PSAs, a high shear mixer like a COWLES dissolver, a batch type rotor stator mixer, or an in-line rotor stator mixer is typically used.

For a 100% solids hot melt bituminous or non-bituminous PSAs, the PSA—including the elastomer, tackifier/bitumen, and plasticizer—may be produced prior to incorporation of the aramid pulp. After rubber solvation is achieved, aramid pulp is incorporated with high shear mixing or other suitable mechanism. Alternatively, the plasticizer, tackifier/asphalt, and plasticizer may be added with the aramid pulp substantially simultaneously. High shear mixing is typically used for this entire process. Rubber solvation generally takes longer to achieve than dispersion of the aramid pulp. Mixing temperatures for these processes may vary from about 275° F. to about 375° F. Rubber solvation may generally be achieved in about 30 minutes to about 2 hours, depending on the type of mixing. Dispersion of the aramid pulp may require anywhere from about 15 minutes to about 1 hour.

Yet another alternative to manufacture embodiments of the current PSA, is to make a concentrate of the aramid pulp in the plasticizer. This can be accomplished with a high shear mixer. This master batch may then be added at any time during the PSA mixing process.

For a solvent-based PSA, aramid pulp can be added to a solution of the PSA and incorporated with a high intensity mixer like a COWLES dissolver or a rotor stator mixer

For an emulsion-based PSA, aramid pulp can be added to the emulsion of the PSA and incorporated with a high intensity mixer like a COWLES dissolver or a rotor stator mixer.

Within the context of the present disclosure, the term “peel strength” refers to a measure of an ability of a material (e.g., composition or membrane taught herein) to stick to another material (e.g., substrate). A material with a higher peel strength has a higher strength to stick to a substrate than a material with lower peel strength. Peel strength is typically recorded as pounds per linear inch (pli) and may be determined by methods known in the art, including, but not limited to ASTM D903 (2017) (peel strength of the membrane to the rigid substrate) and ASTM D1876 (2015) (peel strength of the lap edge to an adjacent membrane). Within the context of the present disclosure, peel strength is measured according to ASTM D903 or ASTM D1876, depending on what is being measured, unless otherwise stated. Preferably, the adhesive composition or membrane taught by the present disclosure has a peel strength at about 40° F. (low temperature) of about 1.5 pli or more, about 1.6 pli or more, about 1.7 pli or more, about 1.8 pli or more, about 1.9 pli or more, about 2.0 pli or more, 2.1 pli or more, 2.2 pli or more, 2.3 pli or more, 2.4 pli or more, 2.5 pli or more, or in any range between any two of these values.

Within the context of the present disclosure, the term “sag resistance” refers to a measure of a material's slump or resistance to flow. A material with a higher sag resistance flows less quickly than a material with a lower sag resistance. Sag resistance, or flow, is typically recorded as centimeter per hour (cm/hr) and may be determined by methods known in the art, including, but not limited to, ASTM D1970 (2009) and ASTM D1204 (2014). Within the context of the present disclosure, sag resistance is measured according to ASTM D1970, unless otherwise stated. Preferably, the adhesive composition or membrane taught by the present disclosure has a sag resistance at about 240° F. (high temperature) of about 10 cm/hr or less, about 5 cm/hr or less, about 1 cm/hr or less, about 0.8 cm/hr or less, about 0.6 cm/hr or less, about 0.4 cm/hr or less, about 0.2 cm/hr or less, about 0.1 cm/hr or less, about 0.08 cm/hr or less, about 0.06 cm/hr or less, about 0.04 cm/hr or less, about 0.02 cm/hr or less, about 0.01 cm/hr or less, about 0.008 cm/hr or less, about 0.006 cm/hr or less, about 0.004 cm/hr or less, about 0.002 cm/hr or less, or in any range between any two of these values.

The invention is further described with reference to the following example embodiments and various exemplary aspects thereof.

In a first example embodiment, the invention provides a composition for a non-cured-in-place PSA having good combination of high temperature sag resistance and low temperature adhesion, comprising:

(a) at least one elastomer;

(b) at least one tackifier or bitumen;

(c) at least one plasticizer; and

(d) a microfibrillar rheology-modifying agent,
wherein the composition is non-cured-in-place and substantially devoid of structural diluents, radical addition diluents, curatives, cross-linkers, and liquid reactive oligomers.

In a first aspect of the first example embodiment above, the phrase “substantially devoid” signifies that the PSA does not require a curing component to achieve adhesive bond strength when the material is applied onto a building substrate.

In a second aspect of the first example embodiment above, the phrase “substantially devoid” means that the PSA has no more than 0.99% by weight of the PSA, or preferably has zero percent by weight, of a component chosen from structural diluents, radical addition diluents, curatives, cross-linkers, and liquid reactive oligomers.

In a second example embodiment, which is based on the first example embodiment above, the invention provides a composition for a non-cured-in-place PSA, wherein the at least one elastomer is chosen from butyl rubber, polyisobutylene, vinyl ethers, styrene-isoprene-styrene (SIS) block copolymers, styrene-ethylene-butylene-styrene (SEBS) block copolymers, styrene-butadiene-styrene (SBS) block copolymers, styrene-butadiene rubber (SBR), ethylene vinyl acetate copolymers, polyisoprene, polybutadiene, polychloroprene, natural rubber, and mixtures thereof.

In a first aspect of the second example embodiment, the non-cured-in-place PSA composition is substantially devoid of acrylic or polyacrylic polymer or copolymer. In this context, the phrase “substantially devoid” means that the PSA composition has no more than 2.99% by weight of the PSA, preferably no more than 1.99% by weight, or more preferably zero percent by weight, of acrylic or polyacrylic polymer or copolymer, of acrylic or polyacrylic polymer or copolymer.

In a third example embodiment, which is based on any of the first through second example embodiments above, the invention provides a composition wherein the at least one tackifier is chosen from rosin esters, hydrogenated rosin esters, dimerized rosin resins, modified rosin resins, aliphatic (C-5 resins) hydrocarbon resins, hydrogenated aliphatic resins, aromatic (C-9 resins) hydrocarbon resins, hydrogenated aromatic resins, mixed aliphatic/aromatic (mixed C-5/C-9 resins) hydrocarbon resins, terpene resins, terpene phenolic resins, and mixtures thereof.

In a fourth example embodiment, which is based on any of the first through third example embodiments above, the invention provides a composition wherein the at least one plasticizer is chosen from paraffinic oils, naphthenic oils, aromatic oils, mineral oils, liquid polyisobutylene, phthalates including alkyl, and mixed alkyl aryl, and phosphates including aryl, alkyl, mixed alkyl aryl, and mixtures thereof.

In a fifth example embodiment, which is based on any of the first through fourth example embodiments above, the invention provides a composition wherein the at least one microfibrillar rheology-modifying additive is a para-aramid pulp with a fiber length ranging from about 0.5 mm to about 2.0 mm and having a surface area of about 3-12 m² per gram.

In a first aspect of the fifth example embodiment, the para-aramid fiber pulp is a thixotropic agent. As used herein, the term “thixotropy” refers to the reversible, time-dependent reduction in viscosity that occurs when the PSA composition is subjected to shear forces.

In a sixth example embodiment, which is based on any of the first through fifth example embodiments above, the invention provides a composition wherein the PSA is a non-bituminous hot melt PSA comprising: a styrene block copolymer chosen from SIS, SBS, SEBS, or mixtures thereof; a plasticizer; a tackifier; and a para-aramid pulp.

In a first aspect of the sixth example embodiment, the rubber level is about 25%-65% by total weight of the PSA.

In a second aspect of the sixth example embodiment, the tackifier level is about 25%-65% by total weight of the PSA.

In a third aspect of the sixth example embodiment, the plasticizer is about 5%-35% by total weight of the PSA.

In a fourth aspect of the sixth example embodiment, the level of para-aramid pulp is about 0.1%-3.0%, more preferably about 0.2%-1.0%, by total weight of the PSA.

In a seventh example embodiment, which is based on any of the first through sixth example embodiments above, the invention provides a composition wherein the PSA is a bituminous PSA having a styrene block copolymer chosen from SIS, SBS, SEBS, or mixtures thereof; a plasticizer; bitumen; and a para-aramid pulp.

In a first aspect of the seventh example embodiment, the rubber level is about 10%-22% by total weight of the PSA.

In a second aspect of the seventh example embodiment, the bitumen level is about 43%-85% by total weight of the PSA.

In a third aspect of the seventh example embodiment, the plasticizer level is about 5%-35% by total weight of the PSA.

In a fourth aspect of the seventh example embodiment, the level of para-aramid pulp is about 0.1%-3.0%, preferably about 0.2%-1.0%, by total weight of the PSA.

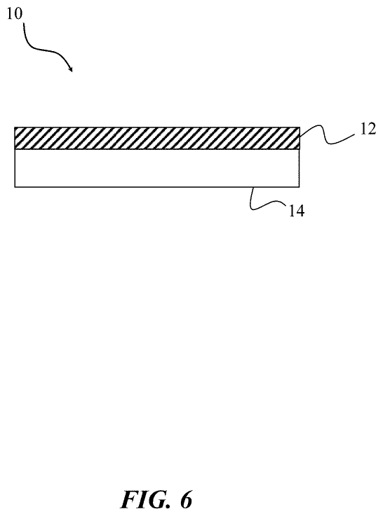

In an eighth example embodiment, depicted in FIG. 6, the present invention provides a membrane indicated generally by reference number 10, comprising:
a carrier sheet (12) and a non-cured-in-place PSA layer (14) having good combination of high temperature sag resistance and low temperature adhesion, the non-cured-in-place PSA layer (14) comprising:
   (a) at least one elastomer,
   (b) at least one tackifier or bitumen,
   (c) at least one plasticizer, and
   (d) a microfibrillar rheology-modifying agent,
wherein the composition is non-cured-in-place and substantially devoid of structural diluents, radical addition diluents, curatives, cross-linkers, and liquid reactive oligomers.

In a ninth example embodiment, which may be based on the eighth example embodiment above, the present invention provides a membrane wherein the PSA layer comprises a non-bituminous, hot melt PSA having a styrene block copolymer chosen from SIS, SBS, SEBS, and mixtures thereof; a plasticizer; a tackifier; and a para-aramid pulp.

In a first aspect of the ninth example embodiment, the rubber level is about 25%-65% by total weight of the PSA.

In a second aspect of the ninth example embodiment, the tackifier level is about 25%-65% by total weight of the PSA.

In a third aspect of the ninth example embodiment, the plasticizer is about 5%-35% by total weight of the PSA.

In a fourth aspect of the ninth example embodiment, the level of para-aramid pulp is about 0.1%-3%, preferably about 0.2%-1.0%, by total weight of the PSA.

In a tenth example embodiment, which may be based on any of the eighth through ninth example embodiments above, the invention provides a membrane wherein the PSA is a bituminous PSA comprising a styrene block copolymer chosen from SIS, SBS, SEBS, or mixtures thereof; a plasticizer; bitumen; and a para-aramid pulp.

In a first aspect of the tenth example embodiment, the rubber level is about 10%-22% by total weight of the PSA.

In a second aspect of the tenth example embodiment, the bitumen level is about 43%-85% by total weight of the PSA.

In a third aspect of the tenth example embodiment, the plasticizer is about 5%-35% by total weight of the PSA.

In a fourth aspect of the tenth example embodiment, the level of para-aramid pulp is about 0.1%-3.0%, preferably about 0.2%-1.0%, by total weight of the PSA.

In an eleventh example embodiment, which may be based on the eighth through tenth example embodiments above, the membrane further comprises a release liner disposed in overlying relation to the PSA.

While the invention is described herein using a limited number of embodiments, these specific embodiments are not intended to limit the scope of the invention as otherwise described and claimed herein. The following examples are given as a specific illustration of embodiments of the claimed invention. It should be understood that the invention is not limited to the specific details set forth in the examples.

### Example

Modified bitumen PSA samples comprising styrene butadiene block copolymer, asphalt, and a plasticizer and oil were prepared with 0%, 0.25%, 0.5%, and 0.75% aramid pulp (e.g., KEVLAR® para-aramid pulp). For all formulations all ingredients except for the aramid pulp (microfibers) were mixed at approximately 350° F. until the polymer was dissolved. The microfibers were dispersed into the formulation with a high-speed rotor stator mixer at high speed for about 20 minutes. Samples of the PSAs were cast onto release paper for sample preparation.

Sag resistance at high temperatures. Resistance to flow or creep (i.e., sag resistance) is measured with the test geometry depicted in FIG. 6. Pickett fence shaped samples of PSA are adhered to a plywood substrate. The assembly is placed vertically in an oven at 240° F. The test was run for 48 hours. The displacement of the adhesive mass past the starting point is measured as a function of time. Results in centimeters per hour are reported in Table 1 as further discussed in the next paragraph.

Adhesion at Low Temperatures.

Adhesion at 40° F. to a polyethylene substrate was evaluated. Samples were conditioned, prepared, and tested at 40° F. Results are reported in Table 1.

Results.

Significant improvement in sag resistance (i.e., decrease in flow) was observed with increasing levels of para-aramid pulp. Additionally and importantly, the addition of aramid pulp was observed to not have an adverse effect on adhesion.

TABLE 1

| Aramid Pulp (%) | 0% | 0.25% | 0.5% | 0.75% |
|---|---|---|---|---|
| Flow @ 240° F. (cm/hr) | 15.5 | 0.057 | 0.029 | 0.003 |
| Peel strength @ 40° F. (pli) | 1.4 | 2.02 | (not tested) | 1.6 |

The foregoing example and embodiments were presented for illustrative purposes only and not intended to limit the scope of the invention.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A composition for a pressure-sensitive adhesive, comprising:
at least one elastomer;
at least one tackifier or bitumen;
at least one plasticizer; and
a microfibrillar rheology-modifying agent,
wherein the composition is non-cured-in-place and is substantially devoid of structural diluents, radical addition diluents, curatives, cross-linkers, and liquid reactive oligomers.

2. The composition of claim 1, wherein the at least one elastomer is selected from the group consisting of butyl rubber, polyisobutylene, vinyl ethers, styrene-isoprene-styrene block copolymers, styrene-ethylene-butylene-styrene block copolymers, styrene-butadiene-styrene block copolymers, styrene-butadiene rubber, ethylene vinyl acetate copolymers, polyisoprene, polybutadiene, polychloroprene, natural rubber, and mixtures thereof.

3. The composition of claim 1, wherein the at least one tackifier is selected from the group consisting of rosin esters, hydrogenated rosin esters, dimerized rosin resins, modified rosin resins, aliphatic (C-5 resins) hydrocarbon resins, hydrogenated aliphatic resins, aromatic (C-9 resins) hydrocarbon resins, hydrogenated aromatic resins, mixed aliphatic/aromatic (mixed C-5/C-9 resins) hydrocarbon resins, terpene resins, terpene phenolic resins, and mixtures thereof.

4. The composition of claim 1, wherein the at least one plasticizer is selected from the group consisting of paraffinic oils, naphthenic oils, aromatic oils, mineral oils, liquid polyisobutylene, phthalates including alkyl, and mixed alkyl aryl, and phosphates including aryl, alkyl, mixed alkyl aryl, and mixtures thereof.

5. The composition of claim 1, wherein the at least one microfibrillar rheology-modifying additive is an aramid pulp.

6. The composition of claim 5, wherein the aramid pulp is present in the composition in an amount of about 0.1% to about 3.0% by total weight of the composition.

7. The composition of claim 5, wherein the aramid pulp is a para-aramid pulp.

8. The composition of claim 6, wherein the para-aramid pulp has a fiber length of about 0.5 mm to about 2.0 mm.

9. The composition of claim 7, wherein the para-aramid pulp has a surface area of about 3 m² per gram to about 12 m² per gram.

10. The composition of claim 1, wherein the pressure-sensitive adhesive is a non-bituminous hot melt pressure-sensitive adhesive.

11. The composition of claim 9, wherein the non-bituminous hot melt pressure-sensitive adhesive comprises the tackifier and a styrene block copolymer chosen from styrene-isoprene-styrene, styrene-butadiene-styrene, styrene-ethylene-butylene-styrene, or mixtures thereof.

12. The composition of claim 1, wherein the pressure-sensitive adhesive is a bituminous pressure-sensitive adhesive.

13. The composition of claim 11, wherein the bituminous pressure-sensitive adhesive comprises the bitumen and a styrene block copolymer chosen from styrene-isoprene-styrene, styrene-butadiene-styrene, styrene-ethylene-butylene-styrene, or mixtures thereof.

14. The composition of claim 1, wherein the composition has a sag resistance of about 0.1 cm/hr or less at 240° F.

15. The composition of claim 14, wherein the composition has a peel strength of about 1.5 pli or more at 40° F.

16. A waterproofing membrane, comprising a carrier sheet and the composition of claim 1.

17. The membrane of claim 13, further comprising a release liner disposed in overlying relation to the pressure-sensitive adhesive.

18. A waterproofing membrane, comprising:
a carrier sheet and a non-cured-in-place pressure-sensitive adhesive layer, wherein the pressure-sensitive adhesive layer has (i) a sag resistance of about 0.1 cm/hr or less at 240° F. and (ii) a peel strength of about 1.5 pli or more at 40° F.,
wherein the pressure-sensitive adhesive layer comprises:
at least one elastomer,
at least one tackifier or bitumen,
at least one plasticizer, and
a microfibrillar rheology-modifying agent comprising a para-aramid pulp in an amount of about 0.1% to about 3.0% by total weight of the pressure-sensitive adhesive layer, wherein the para-aramid pulp has a fiber length of about 0.5 mm to about 2.0 mm and has a surface area of about 3 m² per gram to about 12 m² per gram,
wherein the pressure-sensitive adhesive layer is non-cured-in-place and is substantially devoid of structural diluents, radical addition diluents, curatives, cross-linkers, and liquid reactive oligomers.

19. The membrane of claim 18, further comprising a release liner disposed in overlying relation to the pressure-sensitive adhesive layer.
